(19) United States
(12) Patent Application Publication
(10) Pub. No.: US 2014/0216196 A1
(43) Pub. Date: Aug. 7, 2014

(54) NON-CONTACT TYPE SHIFT LOCK APPARATUS

(71) Applicants: Kia Motors Corporation, Seoul (KR); Hyundai Motor Company, Seoul (KR)

(72) Inventors: Jee-Hyuck Choi, Seongnam (KR); Yang-Rae Cho, Suwon (KR); Dong-Sik Jeong, Daegu (KR)

(21) Appl. No.: 13/946,190

(22) Filed: Jul. 19, 2013

(30) Foreign Application Priority Data
Feb. 6, 2013 (KR) 10-2013-0013135

(51) Int. Cl. F16H 59/02

(52) U.S. Cl. CPC F16H 59/0278
USPC 74/473.24

(57) ABSTRACT

A non-contact shift lock apparatus that includes a coil and a plunger in a housing. More specifically, the plunger moves downward in the housing when power is supplied to the coil. A shift lever locks when the plunger moves downward and unlocks when the plunger moves upward. Further, when power is supplied to the coil, the plunger is magnetized by a magnetic field and a magnetic force focus is formed at the plunger where a magnetic force is concentrated. The plunger is moved downward by magnetic force balance between a center of the magnetic field generated by the coil and the magnetic force focus, so that the position where the plunger moves downward to is determined by the position where the magnetic force focus is formed.

### CROSS-REFERENCE TO RELATED APPLICATION

The present application claims priority to Korean Patent Application No. 10-2013-0013135, filed on Feb. 6, 2013, the entire contents of which is incorporated herein for all purposes by this reference.

### BACKGROUND

(a) Technical Field

The present invention relates to a shift lock apparatus that locks a shift lever when a brake pedal in a vehicle is not pressed down, and more particularly, to a non-contact type shift lock apparatus structurally prevents an impact sound by removing a core that generates an impact sound when a plunger connected with a shift lever slides.

(b) Background Art

A shift lock apparatus is understood by those skilled in the art as a safety apparatus that allows a driver to operate a shift lever only when a brake pedal is pressed down, when shifting from Park (P) to another gear such as Reverse (R), Neutral (N), or Drive (D). These shift lock apparatuses are now mounted in almost all of vehicles with an automatic transmission in order to prevent accidental shifting while the vehicle is parked.

Conventional shift lock apparatuses are typically utilize a solenoid that electrically controls locking and unlocking of a shift lever by sending signals from a brake pedal sensor. For example, FIG. 1, illustrates a conventional shift lock apparatus that includes a coil 2 on the inner side of a housing 3. Operationally, a plunger 1 longitudinally slides inside the coil, when power is supplied to the coil 2.

In these typical arrangements, the plunger 1 is disposed a predetermined distance from a core 2 on the bottom of the housing 3 by a spring (not shown), and when power is supplied to the coil 2, a magnetic field (D) attracts the core 4 (see FIG. 4A), the core moves downward against the elastic force of the spring. The plunger 1 is connected and coupled to a cable or links (not shown) to lock a shift lever (i.e., which restricts movement of the shift lever), when the shift lever is at the upper portion in the housing 3, and to unlock the shift lever, when the shift lever is at a lower portion of the housing 3.

However, when the plunger 1 hits against the core 4 while moving downward in the in the housing 3 in conventional shift lock apparatuses. An impact sound is generated, which is unpleasant to most vehicle drivers.

The description provided above as a related art of the present invention is just for helping understanding the background of the present invention and should not be construed as being included in the related art known by those skilled in the art.

### SUMMARY OF THE DISCLOSURE

Therefore, an object of the present invention is to provide a non-contact shift lock apparatus is able to operate without generating the impact sound of the conventional apparatus. More specifically, the illustrative embodiment of the present invention aligns the center of a magnetic field formed by a coil with the center of a magnetic field of a plunger so that an impact sound can be avoided.

To achieve the objects of the present invention, the present invention provides a non-contact shift lock apparatus which includes a coil and a plunger disposed within a housing. The plunger moves downward in the housing when power is supplied to the coil and a shift lever is locked when the plunger is moved to a downward position and unlocked when the plunger is moved to an upward positing.

Further, in the apparatus, power is supplied to the coil, the plunger is magnetized by a magnetic field and a magnetic force focus (where a magnetic force is concentrated) is formed at the magnetized plunger and the plunger is moved downward by magnetic force balance between the center of the magnetic field generated by the coil and the magnetic force focus, such that the position to where the plunger moves downward toward is determined by the position where the magnetic force focus is formed.

More specifically, the magnetic force focus is formed at a predetermined specific position on the plunger and the specific position is determined so that a space is formed between the lower end of the plunger and the bottom of the housing when the plunger moves downward.

A compression spring may be disposed at the lower end of the plunger (to quickly stop the plunger from moving downward and to prevent impact between the bottom of the housing and the plunger). Additionally, a sub-core that is electrically insulated from the coil and magnetized by the magnetic field generated by the coil may be mounted under the plunger in the housing to attract the plunger. The sub-core may be positioned such that a space is formed between the lower end of the plunger and the sub-core, when the plunger moves downward.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a cross-sectional view of the conventional art and the operation of the shift lock apparatus;

FIG. 2 is a cross sectional view illustrating the operation and the cross-section of a shift lock apparatus according to an exemplary embodiment of the present invention;

FIG. 3 is a view showing the cross-section of a shift lock apparatus according to another exemplary embodiment of the present invention; and

FIGS. 4A-B is a view comparing magnetic fields formed in the shift lock apparatus of the conventional art and a shift lock apparatus according to the present invention, when power is applied.

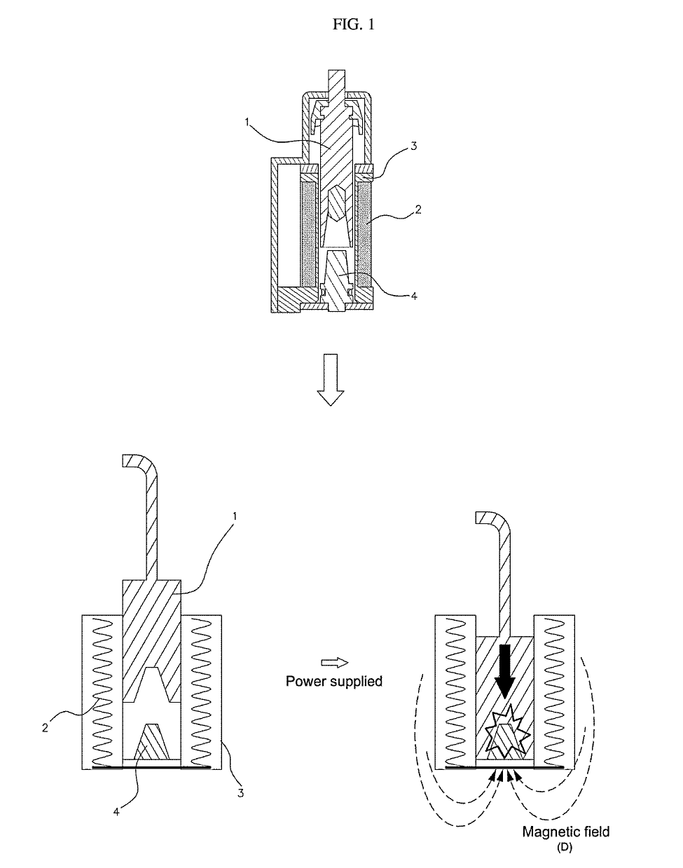

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

According to a shift lock apparatus of the present invention, a coil 20 is disposed within the housing on each side of a channel 15, e.g., around the circumference of the channel to form a substantially vertical cylinder that is opened on a top surface and a bottom surface. Additionally, the coil is configured to be connected to a power source to provide power thereto when power is applied to coil. A plunger 10 is slidably installed inside the channel and within the coil 20 in the housing 30. The plunger 10 may be held at the upper portion by the elastic force of a spring (not shown) and move downward when power is supplied to the coil 20. The plunger 10 may preferably be connected with a shift lever by links or a cable to unlock the shift lever when the plunger moves to a position in the bottom of the housing, and locks the shift lever when the plunger moves to a position at the top of the housing.

Hereinafter, a shift lock apparatus according to an exemplary embodiment of the present invention is described in detail with reference to the accompanying drawings.

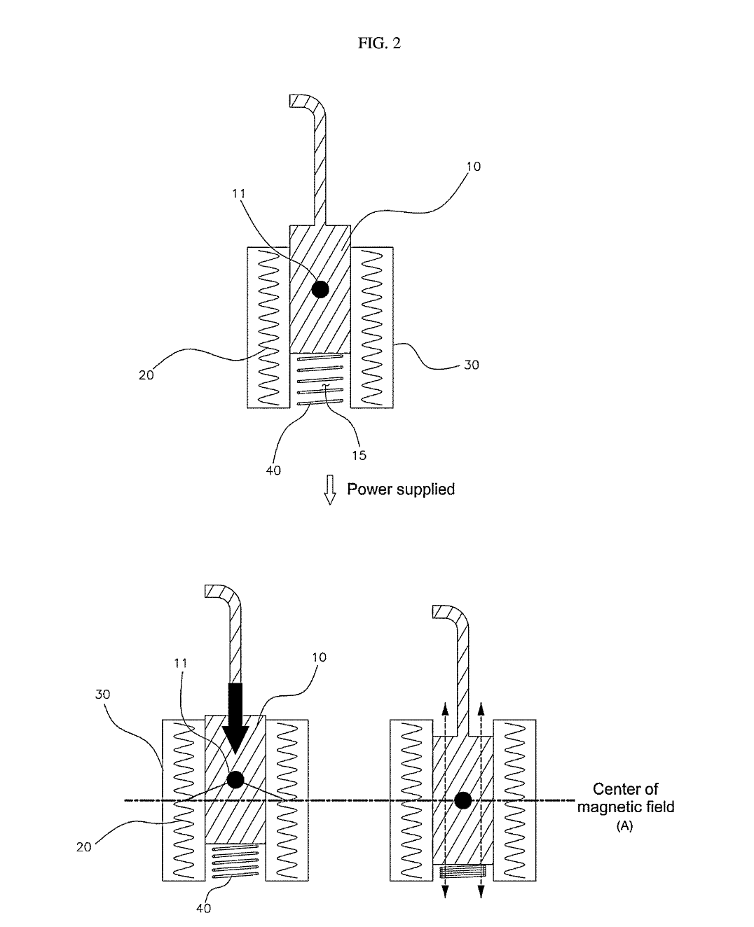

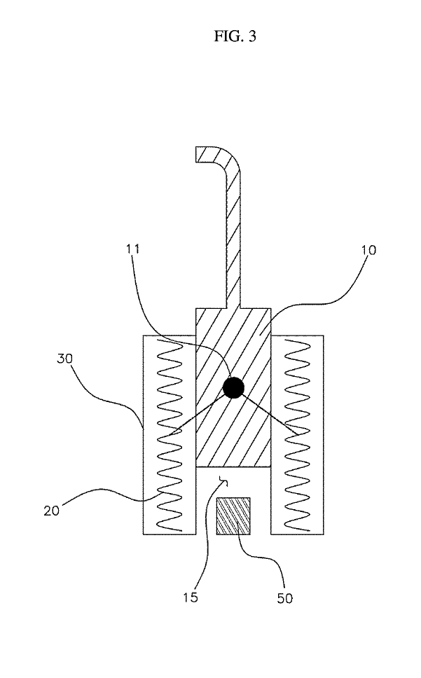

Referring to FIG. 2, according to a shift lock apparatus of the exemplary embodiment of the present invention, the plunger 10 is pulled downward by a magnetic force in the housing 30, when power is supplied to the coil 20. That is, when power is supplied to the coil, a magnetic field is formed around the plunger 10 (i.e., since the plunger 10 is within the channel 15 around which the coil is formed) and the coil 20. As a result of the generated magnetic field, the plunger 10 is moved downward by the magnetic field. In particular, a magnetic force focus 11 is applied to the plunger 10 where the magnetic force of the magnetic field c is concentrated.

That is, the magnetic force focus 11 is configured so that the magnetic force of the magnetic field formed around the plunger 11 is focused on a specific predetermined position on the plunge 10. The magnetic force focus 11 may be formed by additionally mounting a permanent magnet on the plunger 10, combining materials with different magnetisms, or changing the shape of the plunger or utilizing a wound coil as the coil 20, at a specific position on the plunger.

For example, when power is supplied to the coil 20, the magnetic force focus 11 maybe positioned on a center line of the magnetic field A formed around the coil 20 and the plunger 10. Therefore, the position where the plunger 10 moves downward is determined by the position of the magnetic force focus 11 and the magnetic force focus 11 is positioned in an exemplary embodiment of the present invention such that a space is formed between the lower end of the plunger 10 and the bottom of the housing 30 with the plunger moved down, thus preventing any impact sound from being generated. Therefore, in the illustrative embodiment of the present invention, the plunger is suspended above the bottom (floor) the housing/channel.

In some exemplary embodiments of the present invention, a compression spring 40 carrying a compression force may also be disposed on an under-side of the plunger 10 or the bottom of the housing 30 to prevent an impact sound from being generated by the plunger 10 when the plunger 10 moves into its downward position and reaches the bottom of the housing 30.

Further, as shown in FIG. 3, according to another exemplary embodiment of the present invention, a sub-core 50 that is magnetized by the magnetic field generated by the coil receiving power may be additionally disposed at the lower portion in the housing 30 to apply an attraction to the plunger 10.

According to the shift lock apparatus of the exemplary embodiment of the present invention which has the above configuration, the magnetic force focus 11 on the plunger 10 is positioned by maintaining a parallel positioning with the center of the magnetic field (i.e., which is applied only when power is supplied to the coil), such that the core 4 of the conventional art can be removed.

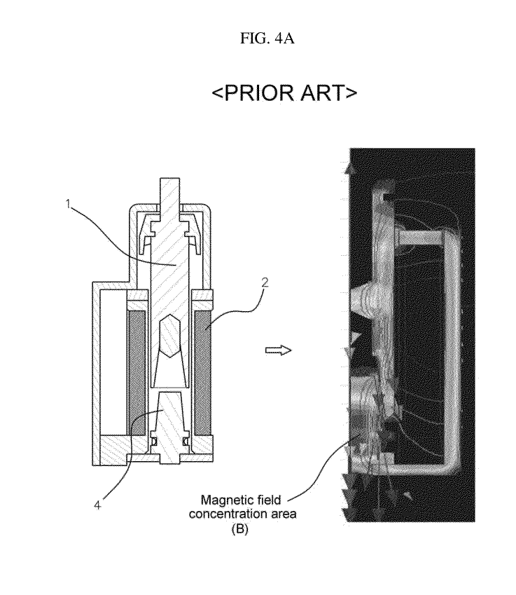

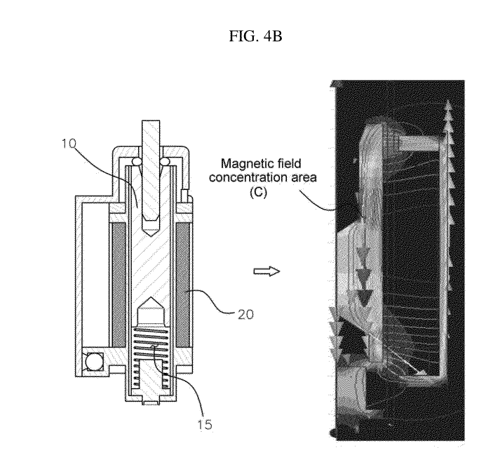

That is, as shown in FIG. 4A, a magnetic force 40a is concentrated on only on the core 4 in the conventional art (refer to the label B of FIG. 4A). However, as can be seen from FIG. 4B, in the illustrative embodiment of the present invention, the plunger 10 is magnetized by the electromagnetic field of the coil when power is supplied and the magnetic force 40b concentrates on the magnetic force focus 11 so that plunger 10 is repositioned (i.e., by moving downward) until with the center of the magnetic force generated by the coil 20 (refer to the label B of FIG. 4B). Therefore, the plunger 10 moved to an unlock position in the bottom of the channel without coming in contact with the bottom of the housing and an impact sound is not generated. Furthermore, even if power is cut, a return sound can be reduced by the compression spring 40 which is mounted under the plunger 10.

Further, according to the exemplary embodiment of the present invention, it is possible to improve an operational force and control of a sliding plunger by means of the sub-core 50 and to reduce the size of the apparatus via increasing the operational force, so that the range of use can be increased. That is, as the sub-core 50, a magnetic material (for example, steel), is disposed in the housing 30 and fixed by an insulating part with the coil 20, and an addition operation force other than the existing magnetic balance force may be generated, thereby increasing the operational force and control of the sliding plunger 10.

In detail, a magnetic field is generated by supplying power to the coil 20 and the sub-core 50 at the lower portion is magnetized by the magnetic field and pulls the plunger 10. Therefore, an additional operation force other than the magnetic balance force between the plunger 10 and the coil 20 is generated. Further, since the sub-core 50 is fixed and insulated from the coil 20, the magnetic force concentration generated in the structure of the conventional art is not generated, such that an impact sound due to contact between the plunger and the core is not generated.

According to the present invention having the above exemplary configuration, a magnetic force due to a magnetic field generated around the coil receiving power concentrates on a specific area on the plunger. More specifically, it is possible to remove a core that generates an impact sound when the plunger slides in the housing by applying a magnetic force focus which suspends the plunger above the bottom surface of the housing (i.e., the plunger never comes in contact with the bottom surface of the housing). That is, it is possible to prevent the lower end of the plunger from contacting the bottom of the housing by means of the compression spring additionally disposed in the lower end of the plunger and it is also possible to improve control of the operational force that slides the plunger by means of the sub-core.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A non-contact type shift lock apparatus comprising:
a coil and a plunger disposed in a housing,
the plunger moving downward in the housing when power is supplied to the coil,
a shift lever locking when the plunger moves downward and unlocking when the plunger moves upward, and when power is supplied to the coil, the plunger is magnetized by a magnetic field,
a magnetic force focus formed where a magnetic force is concentrated at the magnetized plunger and the plunger moved downward by a magnetic force balance between a center of the magnetic field generated by the coil and the magnetic force focus, a position to where the plunger moves downward is determined by the position where the magnetic force focus is formed.

2. The apparatus of claim 1, wherein the magnetic force focus is formed at a predetermined specific position on the plunger and the predetermined specific position allows for a space to be formed between a lower end of the plunger and a bottom of the housing when the plunger moves in a downward direction.

3. The apparatus of claim 2, wherein a compression spring is disposed at the lower end of the plunger.

4. The apparatus of claim 1, wherein a sub-core that is electrically insulated from the coil and magnetized by the magnetic field generated by the coil is mounted under the plunger in the housing to apply an attraction to the plunger.

5. The apparatus of claim 4, wherein the sub-core is positioned so that a space is formed between the lower end of the plunger and the sub-core, when the plunger moves to the downward position.

6. A shift lock apparatus comprising:
a housing;
a plunger movable disposed within the housing;
a coil disposed within the housing; and
a shift lever attached to an upper surface of the plunger,
the plunger magnetized by a magnetic field and a magnetic force focus is formed where a magnetic force concentrates on the magnetized plunger and the plunger moved in a downward direction by a magnetic force balance between a center of the magnetic field generated by the coil and the magnetic force focus, a position to where the plunger moves downward determined by the position where the magnetic force focus is formed.

7. The apparatus of claim 6, wherein the magnetic force focus is formed at a predetermined specific position on the plunger and the predetermined specific position allows for a space to be formed between a lower end of the plunger and a bottom of the housing when the plunger moves in a downward direction.

8. The apparatus of claim 7, wherein a compression spring is disposed at the lower end of the plunger.

9. The apparatus of claim 6, wherein a sub-core, that is electrically insulated from the coil and magnetized by the magnetic field generated by the coil, is mounted under the plunger in the housing to attract the plunger when the power is supplied to the coil.

10. The apparatus of claim 9, wherein the sub-core is positioned so that a space is formed between the lower end of the plunger and the sub-core, when the plunger moves downward.
